(19) United States
(12) Patent Application Publication
(10) Pub. No.: US 2013/0147268 A1
(43) Pub. Date: Jun. 13, 2013

(54) EXTERNAL MAIN SWITCH FOR A HYBRID OR ELECTRIC VEHICLE

(71) Applicant: Jürgen Meurle, Ingolstadt (DE)

(72) Inventor: Jürgen Meurle, Ingolstadt (DE)

(73) Assignee: Audi AG, Ingolstadt (DE)

(21) Appl. No.: 13/513,361

(22) PCT Filed: Dec. 2, 2010
(86) PCT No.: PCT/EP10/07320

§ 371 Date: Jul. 25, 2012

(30) Foreign Application Priority Data
Dec. 4, 2009 (DE) 102009057007.1 4

(51) Int. Cl. H02H 6/00

(52) U.S. Cl. CPC H02H 6/00
USPC 307/10.7

(57) ABSTRACT

A vehicle, in particular a hybrid and/or electric vehicle, includes a main switch for a power supply which main switch can be operated from outside the vehicle, and a safeguard which safeguards the main switch against unauthorized operation. A method for operating a vehicle includes operating a main switch for a voltage supply of the vehicle from outside the vehicle, wherein the main switch is safeguarded against unauthorized operation by a safeguard.

The invention relates to a vehicle, in particular a hybrid and/or electric vehicle, with a main switch for a voltage source, which main switch can be operated from outside the vehicle.

Currently, the power supply in electric vehicles or hybrid vehicles can only be interrupted via a mechanical decoupling at the battery clamp.

When a vehicle has an accident, contact sites can detach and the vehicle voltage can be transferred to the vehicle body. This exposes the emergency personnel to the risk of electric shocks.

From the document http_www.boingboing.net_{—}2008_{—}03_{—}11_teen-prankster-swit.html which was accessible on the Internet on Aug. 14, 2009, the idea is known to provide a vehicle with a main switch for a voltage supply which main switch can be operated from outside the vehicle.

Taking the foregoing into account, the invention is based on the object to increase the safety during operation of a vehicle.

This object is solved by the inventions set forth in the independent claims. Advantageous embodiments follow from the dependent claims.

Accordingly, a vehicle, in particular a hybrid and/or electric vehicle has a main switch for a voltage supply which main switch can be operated from outside the vehicle, and a safeguard which safeguards the main switch from unauthorized operation.

The safeguard has in particular a flap which is arranged on the vehicle body, wherein the main switch is arranged underneath the flap.

The flap can for example be arranged mirror inverted relative to the tank cap.

In order to further increase the safety, the flap is preferably made of a nonconductive material.

In addition or as an alternative, the safety can be increased when the main switch is arranged in an electrostatically shielded area.

Preferably, the vehicle has a safeguard release, which releases and/or turns off the safeguard and with this authorizes the operation of the main switch, when an accident or a system malfunction and/or a requirement for service is detected.

For this, the safeguard release can in particular unlock the flap wherein the flap is preferably opened by spring tension and the main switch becomes directly accessible.

The voltage supply is in particular a voltage supply which is provided by a high voltage battery.

The voltage supply is in particular a voltage supply of a traction motor of the vehicle.

In a method for operating a vehicle, a main switch for a voltage supply can be operated from outside the vehicle and is safeguarded against unauthorized operation by a safeguard.

Further advantages follow from the description of an exemplary embodiment.

Here, a main switch analogous to the tank cap is located underneath a locked cover cap, which is unlocked in case of an emergency or an accident, pivots open (for example via spring preloading) and with this allows access to the main switch.

The accommodation is realized in an electrostatically shielded area (connection to the vehicle body by nonmetallic materials) wherein the cap is also made of plastic.

The main switch is to be accommodated near the battery package in the area before the rear axle for example underneath a hinged lid, which is hinged on one side and is under spring tension, opposite the hinge with a pin and held flush in the outer panel of the vehicle body.

Through the invention, the vehicle can be decoupled from the power supply from the outside without contact with the surface of the vehicle.

The recovery of the vehicle, as well as a recovery of occupants can subsequently occur without risk.

What is claimed is:

1.-10. (canceled)

11. A hybrid and/or electric vehicle comprising:
a main switch for a voltage supply of a traction motor of the vehicle, said main switch being operable from outside the vehicle;
a safeguard for safeguarding the main switch from unauthorized operation, said safeguard comprising a flap; and
a safeguard release configured to release the safeguard in response to detection of at least one member selected from the group consisting of an accident, a system malfunction and a requirement for service, thereby authorizing an operation of the main switch, said safeguard being configured to unlock the flap in response to the member.

12. The vehicle of claim 11, wherein the flap is arranged on the vehicle body, and wherein the main switch is arranged underneath the flap.

13. The vehicle of claim 12, wherein the flap is arranged on the vehicle and mirror image inverted relative to a tank cap of the vehicle.

14. The vehicle of claim 12, wherein the flap is made of a nonconductive material.

15. The vehicle of claim 11, wherein the main switch is arranged in an electrostatically shielded area.

16. The vehicle of claim 11, wherein the safeguard release is configured to open the flap.

17. The vehicle of claim 11, wherein the voltage supply is constructed as a high voltage battery.

18. A method for operating a hybrid and/or electric vehicle, comprising:
releasing a safeguard with a safeguard release of the vehicle in response to detecting at least one member selected from the group consisting of an accident, a system malfunction and a requirement for service, to thereby authorize an operation of a main switch for a voltage supply of a traction motor of the vehicle, wherein the safeguard is configured to safeguard the main switch against unauthorized operation, and wherein the main switch is operable from outside the vehicle; and
unlocking a flap of the safeguard with the safeguard release.
